(19) United States
(12) Patent Application Publication
(10) Pub. No.: US 2022/0410750 A1
(43) Pub. Date: Dec. 29, 2022

(54) SYSTEM AND METHOD FOR SMART CHARGING MANAGEMENT OF ELECTRIC VEHICLE FLEETS

(71) Applicant: MOEV, Inc., (US)

(72) Inventors: Vandana Mangal, Los Angeles, CA (US); Chi-Cheng Chu, Aliso Viejo, CA (US); Yijing Jiang, Los Angeles, CA (US); Wei Lu, Los Angeles, CA (US); Weiheng Yuan, Yorba Linda, CA (US); Jahnvi Ramachandran, Los Angeles, CA (US); Liam Namba, Honolulu, HI (US)

(21) Appl. No.: 17/836,986

(22) Filed: Jun. 9, 2022

Related U.S. Application Data
(60) Provisional application No. 63/208,839, filed on Jun. 9, 2021.
(60) Provisional application No. 63/208,862, filed on Jun. 9, 2021.
(60) Provisional application No. 63/209,132, filed on Jun. 10, 2021.
(60) Provisional application No. 63/209,151, filed on Jun. 10, 2021.

(51) Int. Cl. B60L 53/62; B60L 53/67

(52) U.S. Cl. CPC B60L 53/62; B60L 53/67; B60L 2240/72

(57) ABSTRACT

The present invention provides an artificial intelligence-based system for management of electric vehicles fleet. The system receives live data and historical data feeds from charging stations, fleet telematics, meteorological services, traffic management, mobile application, fleet dashboard, renewable source of energy, battery energy storage system, and the electric utility grid. The system utilizes machine learning algorithms to predict energy usage and optimize the charging schedule of electric vehicle. The system uses real time data to generate electric vehicle trip condition training feature for predicting the remaining driving range. The system predicts the vehicle's arrival time at the charging station based on telematics data of each vehicle collected from the fleet management system.

### CROSS REFERENCE TO RELATED APPLICATIONS

This application claims the benefit of Provisional Patent Application No. 63/208,839, filed Jun. 9, 2021; Provisional Patent Application No. 63/208,862, filed Jun. 9, 2021; Provisional Patent Application No. 63/209,132, filed Jun. 10, 2021; and Provisional Patent Application No. 63/209,151, filed Jun. 10, 2021; the disclosures of which are incorporated herein by reference in their entireties.

### FIELD OF THE INVENTION

The present invention relates to the field of electric vehicle (EV) management, and more particularly, to smart management of charging of electric vehicle fleets.

### BACKGROUND OF THE INVENTION

During the 20th century, petroleum-based vehicles were the most prevalent form of vehicles due to their light and powerful petrol engines, however, with the fear of peak oil and environmental impact of the petroleum-based transportation infrastructure, led to the looking for alternative forms of transport infrastructure. Among other issues associated with the use of petroleum-based vehicles are the issue of rising pollution, global warming and depleting natural resources etc. In the 21st century, with technological developments and an increased focus on renewable energy, the popularity of electric vehicles has risen to prominence.

An electric vehicle (EV) is a vehicle that operates an electric motor instead of an internal combustion engine used in petroleum-based vehicles that generates power by burning a mixture of fuel and gas. The electric vehicle has its power source in form of a battery, solar panels, fuel cells or an electric generator to convert fuel to electricity. Replacement of petroleum-based vehicles with the electric vehicles serves an important source of reducing carbon footprint and other pollutants emission.

Environmental initiatives on a large scale are raising the awareness of companies to switch to more ecological shared, alternative, and multi-mode means of transport. In order to meet renewable energy goals, reduce greenhouse gas emissions, improve air quality and save money, companies are inclined towards creation of their own fleet of electric vehicles. Electric vehicle fleets have many advantages associated with them. In addition to environment benefits, the advantages associated with electric vehicle fleets are: reduced fuel costs, less maintenance required, reduced refueling infrastructure cost, enhanced vehicle performance and efficiencies, etc.

With the companies going towards replacement of gas-based vehicle fleets to electric vehicle fleets, the efficient management of fleets is required due to new requirements to charge the electric vehicles. For efficient management of an electric vehicle fleet, the fleet operator must consider different factors regarding the battery state of charge, time to recharge, the available power capacity from the grid, cost of operating the vehicle and the infrastructure etc.

Therefore, there is a need for a system to efficiently manage electric vehicle fleets. The present invention provides a system and a method based on artificial intelligence to smartly manage charging of electric vehicles in a fleet.

### SUMMARY OF THE INVENTION

In an aspect of present invention, a system for management of electric vehicle charging is provided. The system comprising: a server receives information from a plurality of data sources connected through a network; the server is configured to: consider fleet's charging energy and scheduling requirements by utilizing an artificial intelligence based machine learning model; perform optimization and generates a power flow sequence; send control signals to each of a plurality of energy assets; monitor and determine the plurality of energy assets are performing as per the control signals; modify the control signals if the plurality of energy assets are not performing as per the control signals; present a display dashboard integrated with the server to display the vehicle information to a fleet manager; provide a mobile application interface to display the vehicle information to a driver of the vehicle.

The plurality of data source comprises charging stations, battery energy storage systems, renewable energy source, such as solar photovoltaic, fleet dashboard, traffic data, meteorological data, fleet telematics, power capacity information from electric grid and mobile application. The plurality of energy assets comprises EV charging stations, renewable energy source and battery energy storage systems.

The optimization step comprises scheduling the power charging in combination with the power flows to any of the plurality of energy asset to achieve the maximized utilization of renewable source of energy and minimized electric bill while satisfying vehicle's energy need for the fleet operations.

The display dashboard enables an operator to visualize real-time status about the vehicle and the charger. The mobile application interface display result based on the machine learning model to direct the driver to a precise EV charger location to optimize infrastructure usage.

The system utilizes machine learning model to predict vehicle state of charge, trip prediction and charging operations. The system predicts remaining driving range of the electric vehicle by developing an electric vehicle Trip Condition Training feature for training the machine learning model and an electric vehicle Trip Condition Prediction feature for predicting the remaining driving range from real-time data. The electric vehicle Trip Condition Training feature is generated from the historical data and electric vehicle Trip Condition Prediction feature is generated from real-time telematics and weather/traffic forecast data.

The system is used for driving trip prediction to predict the potential driving route. The machine learning model utilizes telematics data coming from the fleet management system to predict arrival time of the electric vehicle at a charging station. The system performs energy consumption prediction of the electric vehicle to forecast the amount of energy the electric vehicle consumes based on the real-time and historical telematics data.

The system further comprises a method to optimize charging profile of the electric vehicle. The method comprising: utilizing, by machine learning model, the telematics data of the electric vehicle to predict the start and end time of charging for the electric vehicle; generating a time array of charging time of electric vehicle with a specified time interval; mapping hourly billing charges with the time array; generating a time profile corresponding to the hourly billing charges and the capacity of the charging station.

### BRIEF DESCRIPTION OF DRAWINGS

The preferred embodiment of the invention will hereinafter be described in conjunction with the appended drawings provided to illustrate and not to limit the scope of the invention, wherein like designation denote like element and in which:

FIG. 1 illustrates the system architecture for providing smart charging management of an electric vehicle fleet in accordance with an embodiment of the present invention.

FIG. 2 is a flow chart diagram showing a method for management of charging of electric vehicles in accordance with an embodiment of the present invention.

FIG. 3 shows a fleet dashboard to display the fleet information to the fleet manager in accordance with an embodiment of the present invention.

FIG. 4 illustrates a mobile application interface to display information to a driver of the vehicle in accordance with an embodiment of present invention.

FIG. 5 is a graphical representation showing the result of operating expenses (OPEX) reduction via demand charge and vehicle management in accordance with an embodiment of the present invention.

FIG. 6 illustrates the major steps for the utilization of smart charging management system in accordance with an embodiment of present invention.

FIG. 7 illustrates a flow diagram of remaining driving range prediction in accordance with an embodiment of present invention.

FIG. 8 shows a table illustrating the predicted time of arrival and actual time of arrival in accordance with an embodiment of present invention.

FIG. 9 illustrates a table depicting different features used by the system for AI based Machine learning algorithm in accordance with an embodiment of the present invention.

FIG. 10 is a flow chart showing an example of creating charging profile for two vehicles in exemplary embodiment of present invention.

FIG. 11 shows the graphical representation showing results of continuous control on real charging info.

FIG. 12 shows the graphical representation showing results of continuous control on predicted charging info.

FIG. 13 shows the graphical representation showing results of Discrete control on predicted charging info.

### DETAILED DESCRIPTION

The present invention proposes a method that uses artificial intelligence (AI) based machine learning (ML) algorithms in a server to predict energy usage and optimize the charging schedule. The server is connected to a network that receives historical and live data from multiple sources. The system provides artificial intelligence based smart charging management of electric vehicles in a fleet. The data sources from where the historical and live data are received comprises charging stations, fleet telematics, meteorological services, traffic management, mobile application, fleet dashboard, renewable source of energy, battery energy storage system, electric utility grid, etc. The data received from the charging station comprises three phase energy information on real-time charging power, current and voltage for each phase. It also provides the total energy that has been charged for the specific charger up to now. The telematics data includes every second or every minute information of the vehicle as it is being driven or parked or being charged. The information comprises energy being consumed or recovered or idled or charged; the instantaneous power consumed to drive the vehicle, the instantaneous power fed from the regenerating brakes to the battery in the vehicle, the instantaneous power received from the charger; acceleration/deceleration, the speed of the vehicle, the frequency of braking, odometer, GPS information including latitude, longitude, and altitude; the state of charge of the battery in the vehicle, battery voltage and current, battery temperature; weight of the vehicle, and other variables that are related with the vehicle.

The system also fetches information from meteorological services regarding the weather condition and traffic managements system to identify the power consumption impacted by the weather and traffic flow in an area. Since most of the modern EVs are equipped with lithium-ion batteries and the best operating temperature is from 68° F. to 77° F., the cold and hot ambient temperature will significantly decrease the battery's performance. In addition, the driving range can be further reduced due to the energy demands from heater/AC when the temperature and humidity are dropped or increased significantly. The battery consumption can also be affected by the traffic condition. For example, an EV may receive more recharge energy into its battery from its regenerative brake system in heavy traffic than in light traffic. Moreover, windy weather may influence the performance of the vehicle, which affects the total energy consumption of the EV. The real time GPS coordinates from the vehicle's telematics system are used to obtain the related weather and traffic information.

One other information that may affect EV charging optimization is energy production data from on-side renewable sources of energy, such as the solar panels, and the battery energy storage system that provides information on capacity of battery, state of charge of the battery, charging and discharging profile of the battery. The system is also in communication with electric utility grids that provides information on demand response programs and electricity pricing information.

The system receives the above information and processes the information through its machine learning algorithms to generate feasible charging and operational information and present them to the fleet operators and drivers of the electric vehicle. The information is accessed by the fleet operator on the fleet dashboard. The fleet dashboard is a management tool that enables the fleet operator to visualize real time vehicle status, such as status of charge (SOC), remaining driving range, speeds, GPS locations, etc. as well as optimized charging plans and schedules, estimated times for completion of charging, vehicle's driving routes, the arrival time of the vehicle, and the potential energy consumptions and predicted driving ranges are predicted using the developed machine learning methods such as deep learning, neural network, decision tree, random forest, multiple regression, support vector machine and clustering/classifications algorithms. The fleet managers and drivers can run the prediction based on different weather, traffic and route conditions and monitor the results through the dashboard. The system of the present invention manages, monitors, schedules and controls the energy and power flow into the electric vehicles to satisfy the objectives of the fleet operator.

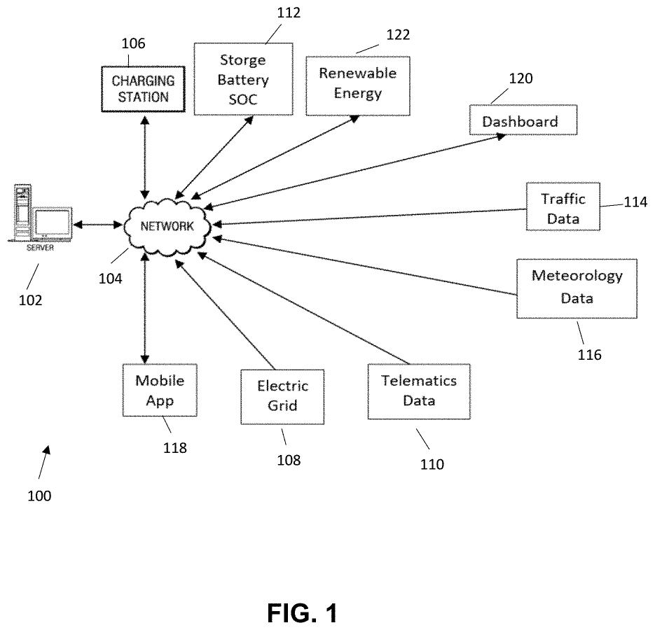

FIG. 1 illustrates system architecture for providing smart charging management of electric vehicles in a fleet in accordance with the embodiment of the present invention. The system 100 is hosted on a cloud server 102 that can be reached through the internet. The system 100 receives real-time telematics data of the electric vehicle and all sorts of related information from multiple sources. The processed and merged data will be fed into the AI/ML system and yield the predictions and optimization strategies based on historical and real-time information. This AI/ML system provides information of the electric vehicle and electric chargers for fleet operators to visualize, analyze, and make decisions on vehicle charging schedules. This AI/ML system has features including but not limited to remaining mileage prediction, driver behavior classification and charging schedule optimization.

The network 104 is connected to a charging station 106. There is a two-way communication between the charging station 106 and the network 104. The charging station 106 is any station, kiosk, garage, power outlet, or other facility for providing electricity to electric vehicles. Electric vehicle receives electricity from, or provides electricity to, an electric grid 108 at a charging station. In other words, electric charge may flow from an electric grid through charging station 106 to the electric vehicle and vice versa. Charging station 106 is a selected charge/discharge site, such as an outlet or kiosk, for providing electric vehicle with access to the electric grid 108. For example, and without limitation, charging station may be a power outlet in a privately owned garage, an electric outlet in a docking station in a commercially owned electric vehicle charging kiosk, or a power outlet in a commercially owned garage.

Electric vehicle connects to charging station 106 via an electrical outlet or other electricity transfer mechanism. The electricity may flow from charging station into electric vehicle to charge electric vehicle.

Electric vehicle and charging station 106 are connected to network 104. The charging station 106 sends and receives data associated with the charging of electric vehicle, the battery capacity of the electric vehicle, the power capacity of the charging station, the current energy stored in the electric vehicle, the rate of charging of the charging station and the electric vehicle, the price of electricity received from a power grid, identity of the owner and/or operator of electric vehicle and/or any other data relevant to charging or discharging electric vehicle over the network. The charging station 106 also communicates information, including current, voltage, frequency of the electric vehicle's charging power. The charging station 106 communicates to the server 102 on a continuous streaming basis. The system 100 utilizes high speed smart metering in each charging station to provide the charging power data stream to the server.

Another source to which server is connected through the network is vehicle telematics 110. The vehicle telematics 110 provides information about the electric vehicle as it is being driven around, or when it is parked, or when it is being charged. The communication between the server 102 and EV telematics 110 is a continuous data stream and the data stream includes information such as, the energy being consumed, the instantaneous power consumed to drive the vehicle, the instantaneous power fed from the regenerating brakes to the battery in the vehicle, acceleration/deceleration, the SOC of the battery 112 in the vehicle, the speed of the vehicle, the frequency of braking and other variables, etc.

For utilizing information on weather and road traffic data, the server is connected to traffic management systems 114 and meteorological systems 116 of the region. An example of such a system can be found at the OpenWeatherMap's One Call API (https://openweathermap.org/api/one-call-api), which includes the information of the temperature, humidity, wind speed and direction. The variations in the weather can result in significant variations in vehicle's energy consumption and therefore, are important parameters in creating accurate predictions related to the energy consumption of the vehicle.

In this invention, the road traffic data 114 is defined as the driving distance and driving time between the vehicle's current location and the destination. Since the operating time of the regenerative braking, accelerations, etc. can give different influences on the remaining driving range during heavy traffic than light traffic, the traffic condition is also considered as an important factor for estimating the EV's driving range in the present invention. An example of obtaining real time traffic information can be found at Google Map Direction API.

The server is connected to an application (an app) 118 installed on the driver's mobile device. The application 118 communicates information about location of the electric vehicle through GPS and other preferences provided by the driver including constraints on delivery schedule or routing, in the case of EV for pickup and drop, to be able to serve the duty cycle needs of the feet operation. Also, elevation (terrain) along the routes of the vehicle impacts energy consumed while driving, and this information is obtained via terrain database such as Google Map Altitude API.

A fleet dashboard 120 is connected to the server through the network. The fleet dashboard 120 mainly has two sections, which are real-time data monitoring and fleet charging arrangement system. The fleet charging arrangement enables the fleet operator to override the charging schemas generated by the artificial intelligence system or algorithms based on immediate needs which may not be reflected in the existing algorithms but can be learnt for future control and management schemes by the artificial intelligence system as inputs provided by the operator. As for the charging arrangement system, there are three processing logics provided for the operator: 1) the operator relies on the algorithm solely and the auto-generated charging schedule by the AI/ML would be provided and shown on the dashboard. 2) The operator assigns the vehicles to the desired charger and an optimized charging schedule with the connection constraint would be provided. 3) The operator turns off the smart charging algorithm and manually charges the vehicles.

The server 102 is in communication with energy generation system and battery energy storage systems and electric utility grid. The energy renewable generation system 122, such as the solar panels, provides energy production data from on-side generation which includes the amount of power being generated historically and in real time. The battery energy storage system communicates to the server about the state of the battery energy storage system and the information comprises total capacity of the battery in kilowatt-hour (kWh), real SOC of the battery, historical charging and discharging profiles of the battery, etc.

The electric utility communicates grid status through Demand Response (DR) program. It offers monetary incentive to help ease stress on the grid and prevent outages. The current invention contains a Demand Response Automation Server (DRAS) that accepts demand response events from the utility and the AI/ML system will increase or reduce vehicle charging power depending on the demand response event received.

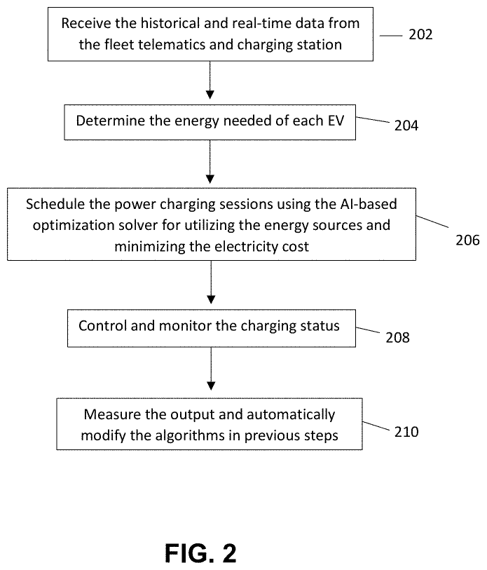

FIG. 2 is a flow chart diagram showing a method for management of charging of electric vehicles in accordance with an embodiment of the present invention. In the first step 202, the historical and real-time data from the fleet telematics and the charging stations are received. In step 204, the EV's energy consumption prediction method then determines how much energy is needed by each vehicle and by what time.

In the next step 206, the server utilizes artificial intelligence enabled optimization to schedule the power charging in combination with the power flows to any of the energy assets to achieve the maximized utilization of renewable sources of energy and to minimize the cost of electricity. After the optimization and power flow sequence is generated by the server, in the next step, the server sends the appropriate control signals to each energy asset. The energy asset comprises EV charging stations, solar panel, or stationary batteries. The server monitors the effectiveness of the schedule in step 208. In the next step 210, the server monitors the charging stations to determine if the charging stations are performing as per the control signals sent by the server. If the assets are not performing as per the power requirement from the control signals, then the charging rate is modified in real time to achieve the desired optimization goals. The server therefore measures the outcome of third step and uses artificial intelligence and machine learning to automatically modify algorithms in the previous steps. In the next step, the server utilizes the artificial intelligence-enabled optimization solver to adjust the charging power in combination with the power flows to any of the energy assets to achieve the maximized utilization of renewable sources of energy and to minimize the cost of electricity. The server monitors the charging stations every minute to determine if the charging stations are performing as per the control signals sent by the server. In case, if the system detects any happened or potential abnormal phenomenon from the real-time data of the energy assets and the vehicles, the system records the error information, analyzes the possible reasons, takes proper adjustments, and informs the fleet operator with the error notification. The server, therefore, measures the outcome and uses artificial intelligence and machine learning to automatically modify the power flow as needed.

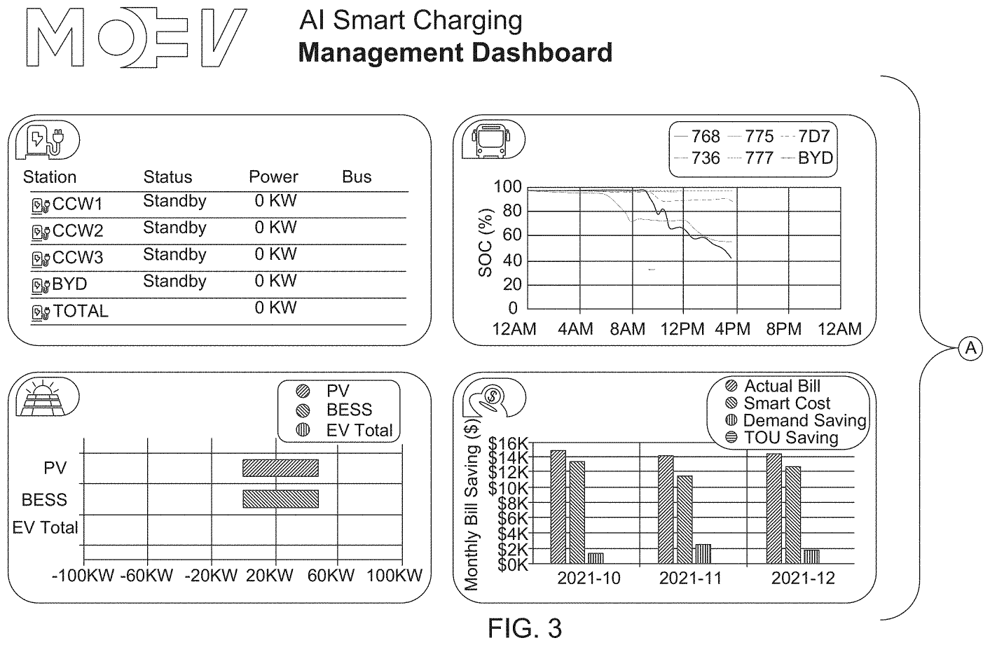

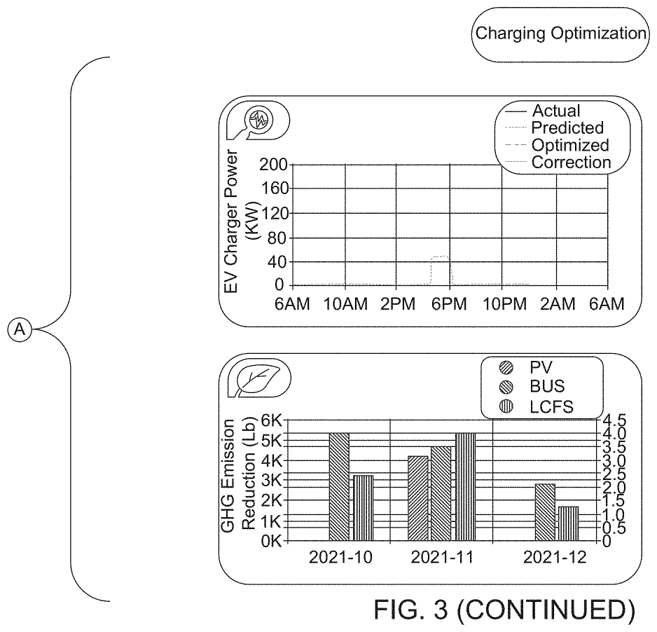

FIG. 3 shows a fleet dashboard 300 to display the fleet information to the fleet manager in accordance with an embodiment of the present invention. The fleet dashboard 300 is integrated with the AL/ML system in the current invention. The cloud-based system enables management and control of charging stations. The dashboard 300 is a management tool provided to the fleet operator and it enables the operator to visualize vehicle's real-time status and the charging status of the chargers. On the vehicle information, the prediction of vehicle SOC, predicted trips/routes and charging operations, etc. are provided based on the results obtained from the AI/ML algorithms. The operator is provided the ability to check the vehicle's real-time positions through the API provided by mapping services such as Google map and telematic systems on the vehicle. The artificial intelligence reduces demand charges by learning the site host energy needs, fleet operational requirements and driver behaviors. It also enables the fleet operator to override the charging schedule based on immediate needs which may not be reflected in the existing algorithms but are learnt for future control and management schemes by the AI algorithms as the inputs provided by the operator. The fleet operator has access to a power management dashboard along with the statistics data and analytics to help them better manage the fleet operations.

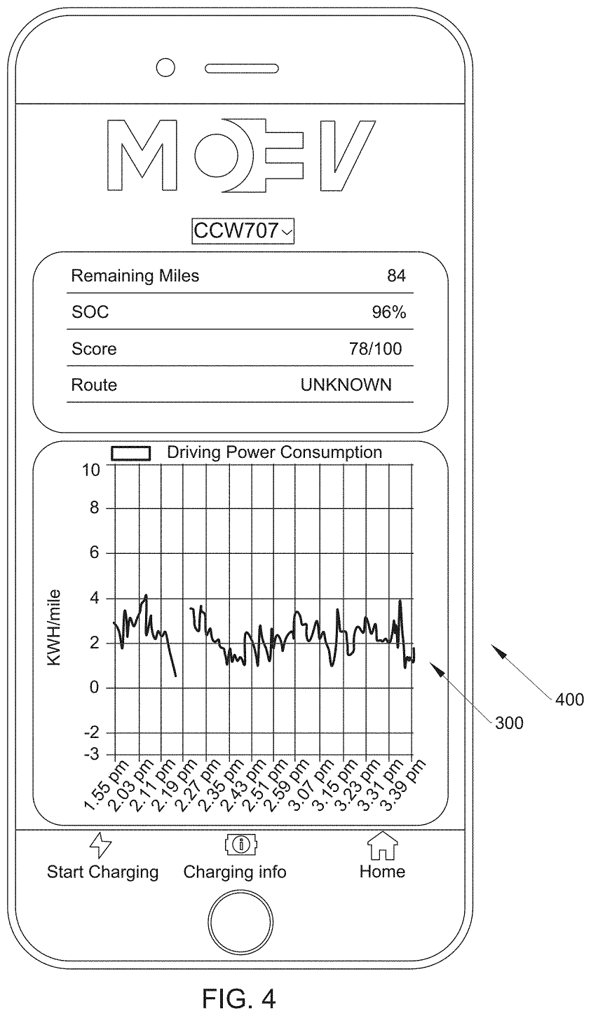

FIG. 4 shows a mobile application interface 400 displaying information to a driver of the vehicle in accordance with an embodiment of present invention. The mobile application 400 is installed on the mobile device of the driver of the electric vehicle. The application provides real time information on the vehicle status, including SOC, remaining miles, driving score which is related to driver behaviors and driving patterns, etc. The app ensures an adequate driving range for a given day's driving needs. The application directs drivers to precise EV charger location to optimize infrastructure usage and minimize electric bill. The application updates electric vehicle information in real time by retrieving information from vehicle's telematics system and displays available chargers by retrieving information from EV charging network.

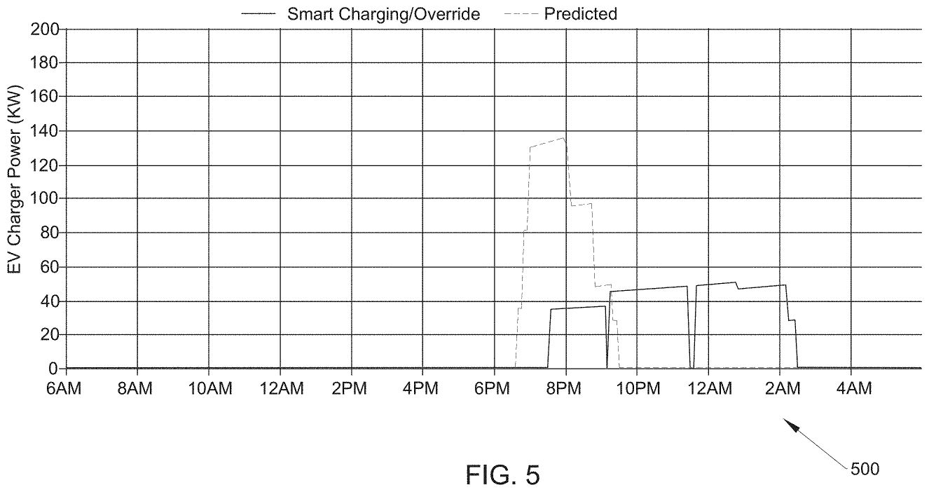

FIG. 5 is a graphical representation 500 showing the result of OPEX reduction via demand charge and vehicle management in accordance with an embodiment of the present invention. FIG. 5 shows the result of electricity usage when the fleet is managed by AI based machine learning software. The result shows that there is an overall reduction of 60% of demand charge by arranging the vehicles to be charged sequentially instead of simultaneously.

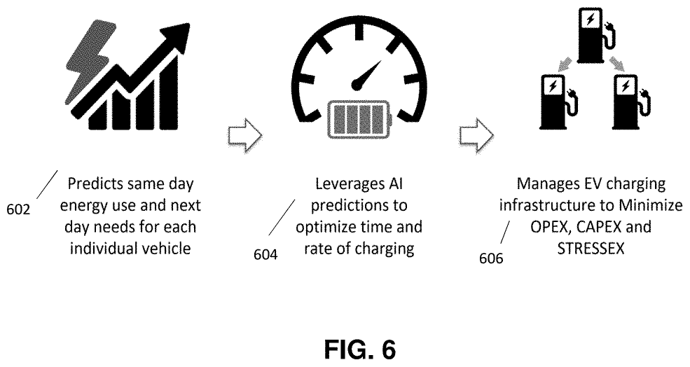

FIG. 6 shows the utilization of the current smart charging management system in accordance with an embodiment of present invention. FIG. 6 shows the objective achieved by utilizing the charging management system on a fleet of vehicles. In a fleet depot, when each of the vehicles starts to approach the depot, the server predicts how much energy each vehicle will need to serve the duty cycle needs of the next shift 602. Based on the outcome 604, the server guides the vehicle into a specific charging station to maximize the utilization of the charging infrastructure capacity, thereby maximizing the utilization of the capital expenditure (CAPEX) 606. For instance, if there are ten electric vehicles that need to be charged across ten charging stations, and if a vehicle needs 100 kWh over a ten-hour period, it would require a minimum power capacity of 10 kW for a charging station. The system optimizes and determines which charging station would be used by a given vehicle. The system therefore achieves following objectives by optimizing the charging needs: (i) maximizing the return on CAPEX; (ii) managing the overall electric flow into each of the vehicle to reduce the electric bill and minimize OPEX via minimization of the electric bill; and (iii) ensures that the EV driver gets the correct amount of charging and guides them to the appropriate charging station through the mobile application.

### Remaining Driving Range Prediction

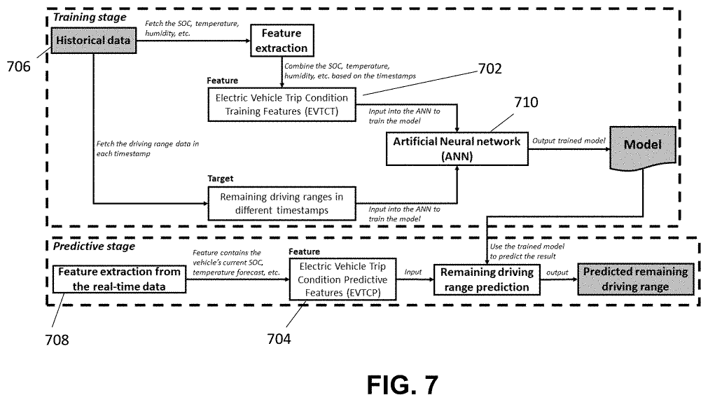

As show in FIG. 7, for the remaining driving range prediction, two feature sets called electric vehicle Trip Condition Training features (EVTCT) 702 and electric vehicle Trip Condition Prediction features (EVTCP) 704 are developed for training the machine learning model and predicting the remaining driving range from real-time data, respectively.

EVTCT and EVTCP consider the driving range changes that are strongly affected by the driving behaviors, vehicle conditions, weather information, traffic status, and driving routes. The limited size of two feature sets will improve the performance of the deep learning, and allow important relationships and rules be learnt by the system more efficiently.

The EVTCT is generated from the historical data 706. The EVTCT consists of the following features:
1) State of Charges (SOC) of every 5 minutes
2) Weather information of every 1 hour:
   a) Temperature
   b) Humidity
   c) Wind speed and direction
3) Traffic information based on the vehicle's GPS location records
   a) Remaining distance to the destination
   b) Remaining time to the destination
4) Acceleration data of every 5 minutes
5) Trip Route
6) Route altitude of next 1 mile
7) Vehicle load

In this invention, 5 minutes are used as the data frequency of the SOC and acceleration, 1 hour as the data frequency of the weather condition, and 1 mile as the range of the road altitude trends. However, the data frequency and data range of the SOC, acceleration, and weather information and altitudes can be changed according to the capacity of the sensor and/or network that's providing the data. The training target of EVTCT is the remaining travel distance records in the telematics dataset.

The EVTCP is built from real-time telematics and weather/traffic forecast data 708. It includes the following features:
1) State of Charges (SOC) of the vehicle in the previous 5 minutes
2) Weather forecast information of the next 1 hour:
   a) Temperature
   b) Humidity
   c) Wind speed and direction
3) Traffic information based on the vehicle's real-time GPS location
   a) Remaining distance to the destination
   b) Remaining time to the destination
4) Vehicle's accelerations of previous 5 minutes
5) Current trip route
6) Current route altitude of next 1 mile
7) Current vehicle load

In this invention, 5 minutes are used as the data frequency of the SOC and vehicle's previous acceleration, 1 hour as the data frequency of the weather condition forecasting, and 1 mile as the upcoming range of the road altitude. However, the data frequency and data range of the SOC, acceleration, and weather information and altitudes can be changed according to the needed prediction data frequency and network that's providing the predicted data.

An Artificial Neural Network (ANN) 710 with 3 hidden layers is used for training the deep learning model and predicting the result. The predicted result represents the EV's potential driving range when the driver keeps the same driving style as the previous 5 minutes on the route with the road traffic and weather conditions ahead provided by the meteorological and traffic services systems.

The steps of the invention are as follows:
1) Collect related historical data and construct the EVTCT.
2) Build the ANN and generate the deep learning model from the EVTCT.
   a) Search the optimal ANN hyper-parameters
   b) Generate the deep learning model
   c) Evaluate the model
3) Build the EVTCP from the vehicle's real-time telematics data, traffic conditions, weather forecast data, current route information and vehicle weight.
4) Use the Machine Learning programming tools such as TensorFlow Lite library to perform the prediction of remaining driving range.

### Trip Prediction

In a fleet operation, vehicles often have routine trips and routes, for example, transit bus and delivery trucks use the similar routes on their trips. Prediction of the departure time, arriving time and range of the trips are crucial to estimate the energy needed for the electric vehicle to complete these trips. Subsequently, the estimated energy needed can be used for optimizing the electric vehicle charging schedules.

The driving trip prediction uses the last three days' trip records of the vehicle combined with an artificial recurrent neural network (RNN) called Long short-term memory (LSTM) to predict today's potential driving routes.

### Arrival Time Prediction

The system utilizes telematics data of each vehicle collected from the fleet management system. The method involves the steps of classification and regression in machine learning. During the classification step, it classifies whether at a particular time, the vehicle will arrive or not at the charging station. In the regression step, the method further narrows down the time of arrival by predicting how much time in minutes is left for the vehicle to arrive at the charging station.

The method involves the steps of preprocess the dataset; train machine learning models for the regression and classification; improve the performance of the classification and regression using a deep learning algorithm. During the preprocessing step, the technique involves cleaning the dataset and setting the correct features to be fed into the machine learning model. The machine learning algorithm for the regression and classification involves using machine learning to increase the accuracy, decrease the error and hence improve the overall efficiency. The deep learning algorithm employs deep learning models to perform the classification and regression to further improve the accuracy, reduce the error and catch more details of the relationships between the prediction targets and features.

In the preprocessing step, telematics data coming from the fleet management system is used. The dataset contains features, such as charge cycle, energy charged per day, energy consumed, energy driven, energy idled per day, energy used in different processes, energy recovered per day, distance driven per day, power battery SOC data, speed, and GPS locations. The missing values of a feature will be filled with the related last known values, or the average of the last available previous values and first available next values in that feature. If the value is missing over a long period, it is assumed that no energy is consumed, and the value is set to zero. The value of energy charged per day is set to 0 at the start of each energy charge. Furthermore, the dataset is extended by adding a new set of rows in a time spanning from 00:00 to 23:59 for the arrival time prediction of the next day. The values of the year, day, month, hour, minute, time of day (Classified into Morning, Afternoon, Evening, Night, Midnight), week of the year, day of the week, and “is weekend” are separated from the other columns and added to the dataset as new columns. The newly created columns in the previous steps are label encoded or hot encoded. Two additional columns called “is_charging” and “minutes to charge” are also added to the dataset as the prediction targets for the classification and regression. The value of a “is_charging” is set to 0 when the related “Energy charged per day” column has a null/no value, and 1 otherwise. The value of a “minutes to charge” is set to 0 when the related “Energy charged per day” column has a null/no value, and 1 otherwise. A rolling window of size=5 is used to select the feature by calculating the mean and median values.

The pre-processed data is split into X and Y, where X defines the features and Y defines the target. The X contains features such as data on charge cycle, energy changed, recovered energy, position of vehicle, battery SOC, GPS, day, date, time, etc. The Y is the “is_charging” for the classification and “minutes to charge” for the regression. The features of X are further selected using principal component analysis (PCA) and p-values of each feature pair.

The p-value correlation between X and Y is calculated using chi-squared test to find if each column of features in X contributes to the prediction in y or the target column. If the p-value is larger than 7%, that implies the occurrence of the data is because of coincidence and not correlation.

For machine learning, the dataset is split into train and test. The train dataset is further split into train and validation such that 95% is train and 5% is validation. In the first split, the Train data 1 is formed as 1 year of data without the next day added in Pre-processing part. The test data is prepared as the new day's data from 00:00 to 23:59 added in step pre-processing part. In the second split to form train data 2 and validation data, the train data 2 comprises 95% of Train Data 1 and the validation data is 5% of Train data 1. The test data will remain same as test data in first split.

The dimensionality of the dataset is further reduced using Principal component analysis (PCA) on the train set. Dimensionality is same as the number of columns in X or feature section. Each column is a dimension in the space. GPS_lat_lag_1 hour is say x axis, then GPs_lat_lag_2 hour is y axis and so on. Hence the number of columns is equal to the number of dimensions. PCA is performed to project all the datapoints into a new feature space that considerably reduces the dimension. The dimension can be reduced from 100 to 3 or 4. This reduces the complexity and maintains the initial accuracy.

In the machine learning algorithm, the Logistic regression, K-Nearest neighbors, k-means, cart trees, support vector classification, random forest classifier, and gradient boost classifier are used for the classification. Linear Regression, support vector machines and regression trees are utilized for the regression. In the deep learning algorithm, long short term memory (LSTM) is used for improving the accuracy of the classification and the regression.

The train and validation datasets are combined to the final Machine Learning model and fit to the test set. The accuracy for classification root-mean-square deviation (RMSE) for regression is checked and values are reported. The first occurrence of value 1 in is_charging or minutes_to_charge is the start charging/arrival time. The time for both predicted and actual is fetched and compare and plot the lags or delays in predicted as compared to actual.

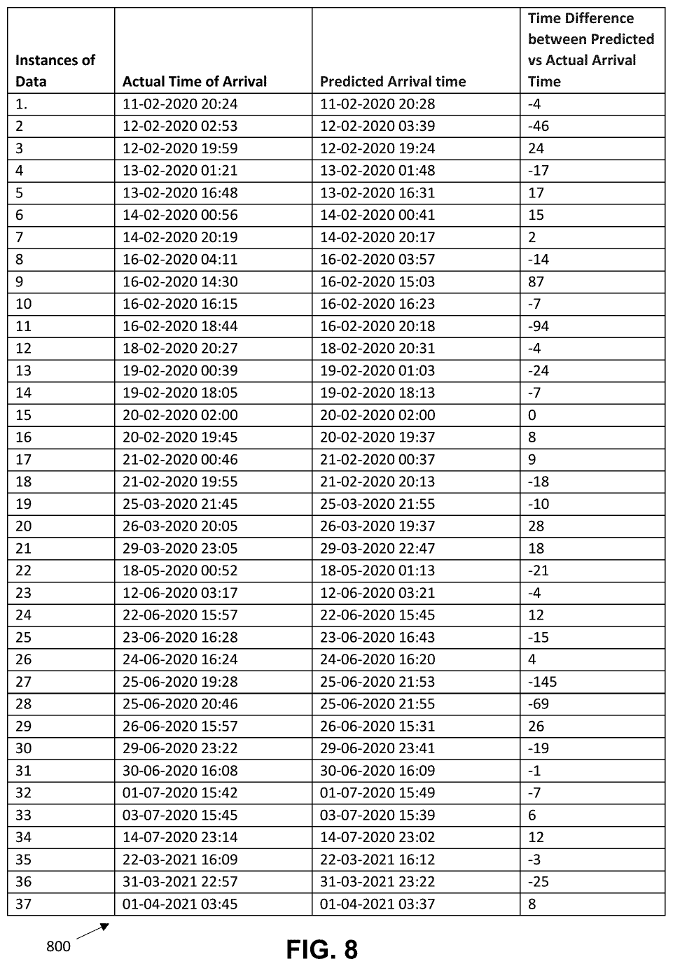

FIG. 8 illustrates a graphical representation 800 of the results processed by the machine learning algorithm in accordance with an embodiment of present invention. As shown in FIG. 8. the prediction results of 37 vehicles show the system can predict the time of arrival with a lag or delay of 10 minutes most of the time. The model is in conformity with the arrival time as predicted for different vehicles.

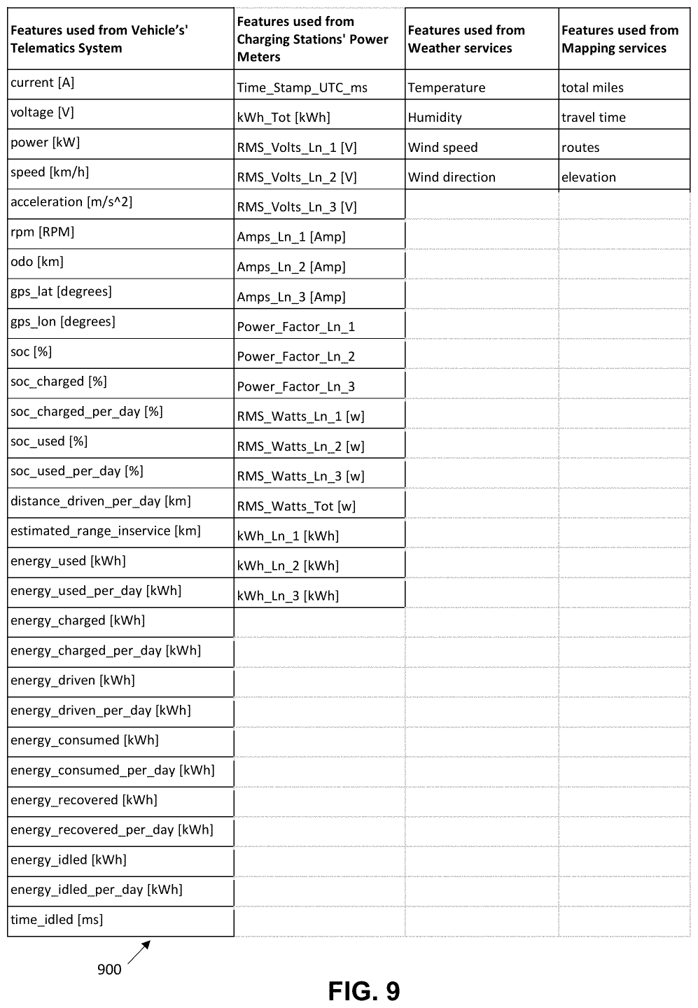

FIG. 9 illustrates a table 900 depicting different features used by the system for AI based Machine learning algorithm in accordance with an embodiment of the present invention.

### Energy Consumption Prediction

In an embodiment, the present invention provides a system perform the energy consumption prediction of the EVs to forecast how much energy the electric vehicle will consume based on the real-time and historical telematics data. The system utilizes machine learning module that will use input from the vehicle database and output the expected energy consumption of the vehicle. It can provide the continuous energy consumption forecast of each EV in a fleet for up to 24 hours.

The dataset for training the machine learning model includes the telematics data and power meter data from the charging station. The telematics data of the vehicle comprises the time of the day, odometer, distance traveled, battery state of charge, charge cycles, GPS data. The power meter data from the charging station comprises three power phase data on total kilowatt-hour, voltage on different phases, current at different phases, power factor for different phases, total watts, frequency, reverse kilowatt-hour on different phases, total net watts, and net watts on different phases.

The features within the dataset are selected before training the models. The features that have too much missing data are eliminated, and the features with intact data are interpolated using the average value, Gaussian distribution, or just omitting the entry. The processed features will be further eliminated by running a correlation matrix on features to see the correlation between two features. The heavily correlated features are eliminated to reduce the dimensionality. For the inputs, lagged value and time-series features are generated in different periods of time sizes. The input features are then normalized and corrected.

For generating the prediction model from the dataset of the vehicle, the training set and the test set are in the ratio of 80 to 20 or 70 to 30. The dataset can also be split into training, cross-validation, and test data. The dataset can be split into 60% of training data, 20% for cross-validation, and 20% for testing. The machine learning model is selected from the group comprising Linear Regression, Support Vector Machine, Elastic net, and Random Forrest Regression.

Each model is evaluated using walk-forward validation and cross validation. A matrix is generated to summarize the validation results of all models. It contains the evaluation categories including mean absolute error (average magnitude of errors, regardless of direction), root mean squared error (square root of average, squared differences), mean absolute percentage error, and R2 score. The model with the best scores in most of the evaluation categories will be chosen for that EV's prediction model.

The prediction is a recursive multi-step forecasting process. For a particular time-step, the prediction of charging status is carried out and the result of this prediction is then used as one of the inputs for predicting the forecast for the next time step from the trained model. The process is repeated 24 times for each 24-hour prediction.

### Charging Optimization

The system of the present invention manages, monitors, schedules and controls the energy and power flow into the electric vehicles to satisfy the objectives of the fleet operator. In an embodiment of the present invention, the objective of the present invention is to minimize the bill cost associated with charging while satisfying the energy need for fleet operation. This is achieved via a combination of minimization of demand charges and optimization around the Time-Of-Use (TOU) pricing considering the previous and future charging performances in the billing cycle. The system takes into consideration different parameters associated with electric vehicles, energy resources, and grid distribution to create strict constraints, including the predicted energy consumption of the next working period for electric vehicles, the predicted arrival and departure time of electric vehicles, the energy required for electric vehicles, real-time battery state of charge of electric vehicles, power capacity and usage restrictions from the energy resources, bill information and charges levied for electricity at the different time period from the grid, the peak power in the current billing cycle so far, etc.

The system achieves the objective by modulation of the continuous or discrete electric power that is fed into and out of the different distributed energy resources on the sites, including the electric vehicles, electric chargers, stationary batteries, and solar panels, etc. The information such as charging required for the electric vehicle, consumption of power and battery state of charge can be collected from a fleet telematics system. The system then predicts the charging power capacity of the chargers, the starting and ending time of charging for the electric vehicle along with the predicted energy needed for charging the electric vehicle. The system first converts the available charging time of electric vehicles into a time array with a specific time interval.

The system then maps the hourly billing information with the time array. Once the energy needed of electric vehicles and the power capacity of energy resources have been identified, the system determines the time array and the cost associated with the historical power distribution and the current time period in the time array where the charges are minimum.

The system generates the charging profile for both continuous and discrete controlled energy resources. The system predicts the energy needed for each charging session of each electric vehicle. The system collects current battery SOC from vehicle's telematic data and performs historical time series data to obtained the energy consumed hourly in the future. The system also extracts information on full capacity of the electric vehicle. The details on the charging time, i.e. starting and ending time of vehicle charging is determined. The system computes the battery SOC till the start of charging session and the energy consumed after the charging session. According to the SOC range, the optimal SOC at the end of charging session is calculated. The starting SOC and ending SOC is compared to obtain the energy needed in this charging session. The result of prediction is then calculated for the EV with details such as starting time, ending time, predicted energy needed.

The system also takes into consideration the operational requirements and the preference of charging schedule as soft constraints, including the available operational time of the fleet operator, the preferred chargers, the preferred charging order for electric vehicles, etc.

For optimization, the system fetch inputs parameter such as time available (T), number of vehicles (N), 1-dimentional (1d) array for energy needed by vehicles (F), 1d array of charging power capacity of vehicles (C), 2-dimentional (2d) array of available charging time of vehicles (N,T), demand price and energy price according to time available and minimum starting time. Since there are two modes of control, the variables are defined are as follow:
1. For continuous control:
   a. charging power: shape=(N, T); lower bound=0, upper bound=C;
   b. charging time′: shape=(N, T); lower bound=0; upper bound=time;
2. For discrete control:
   a. charging time′: shape=(N, T); lower bound=0; upper bound=time;
   b. charging power: shape=(N, T); value will be computed from the charging time′ variable during the optimization process:

powerᵢⱼ={Cᵢ , if time′ᵢⱼ>0; 0,if time′ᵢⱼ=0}

In the next step, constraint equations are defined to compute the results. The constrains equations are defined as follows:
3. For each vehicle i ∈ [0, N], energy needed should be satisfied:

$${\sum }_{j = 0}^{T} ( p o w e {r}_{ij} \times {time}_{ij}^{′} ) = {F}_{i} , ∀ i ∈ [ 0 , 1 , 2 , … , N ]$$

4. Convert the problem of minimizing the peak variable to the problem of minimizing all the variables:

$$energy price cost + demand cost \leq total cost$$

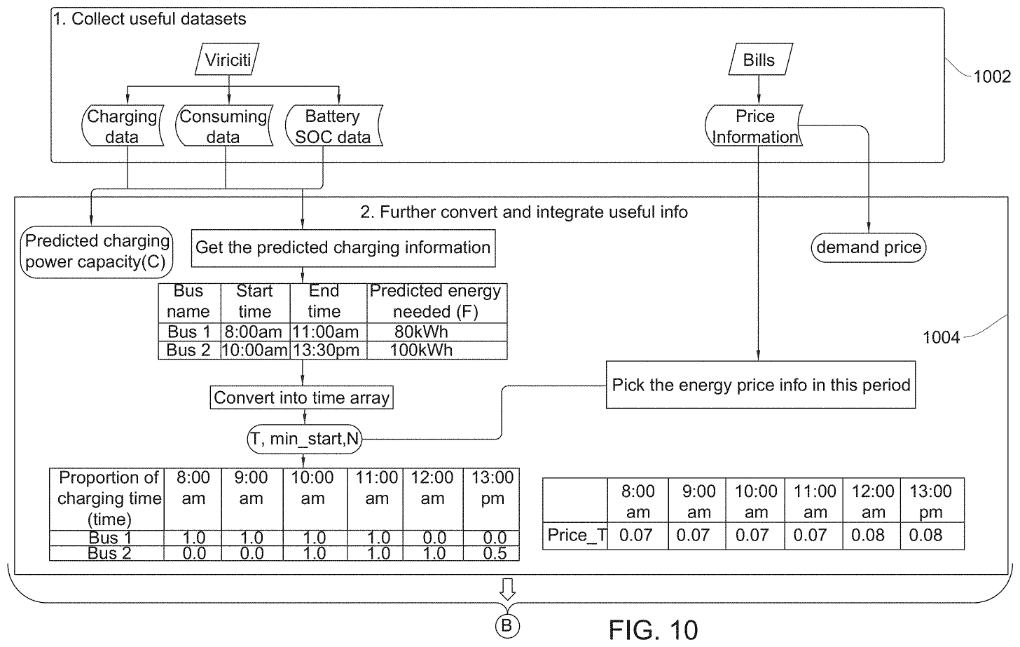

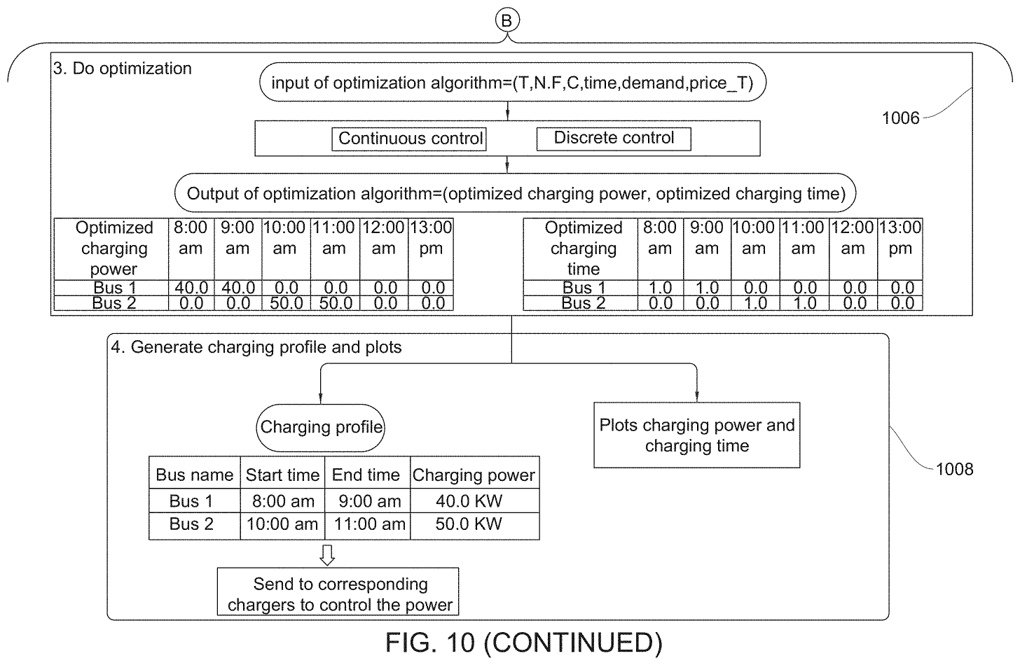

FIG. 10 is a flow chart showing an example of creating charging profile for two vehicles in exemplary embodiment of present invention. As shown in FIG. 10, the useful data set information 1002 such as charging data, consuming data and battery SOC data is collected for the vehicle and the charging station. Similarly, price information, demand prices are fetched from utility billing systems. The system then converts and integrates useful information based on the primary information. The system predicts 1004 the charging power capacity of charging station and predicted charging information for two electric vehicles (EVs): EV1 and EV2 in the given example. The starting time for EV1 is 8 am to 11 am and that for EV2 is 10 am to 1:30 pm with predicted energy need of 80 kWh and 100 kwh respectively. The time information is then converted into time array with 1 hour time interval. The energy price information is matched into this period. The predicted charging in time array for EV1 is 1 hour in each time interval in time array form 8 to 11 am. The predicted charging time for EV2 is 10-11, 11-12, 12-1 and 1-1.30. During the optimization process 1006, the system considers the pricing information for different time interval and creates charging profile for EV1 and EV2. The charging time for EV1 is determined for 8 to 10 am with each hour charging 40 kWh of energy. The charging profile 1008 for EV2 is determined as 10 to 12 am with each hour charging 50 kWh of energy to the EV2.

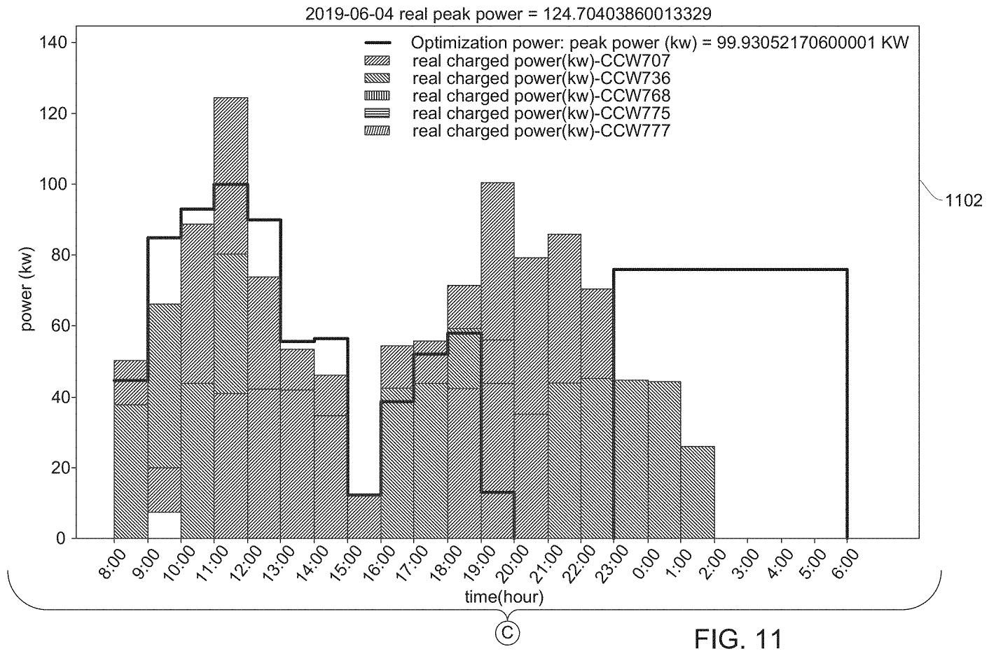

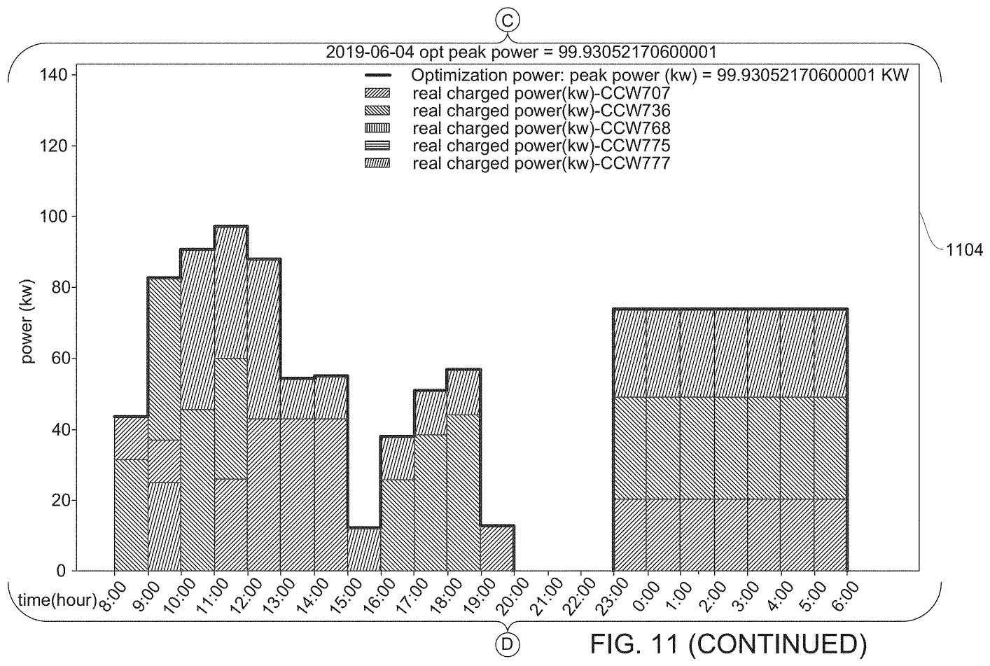

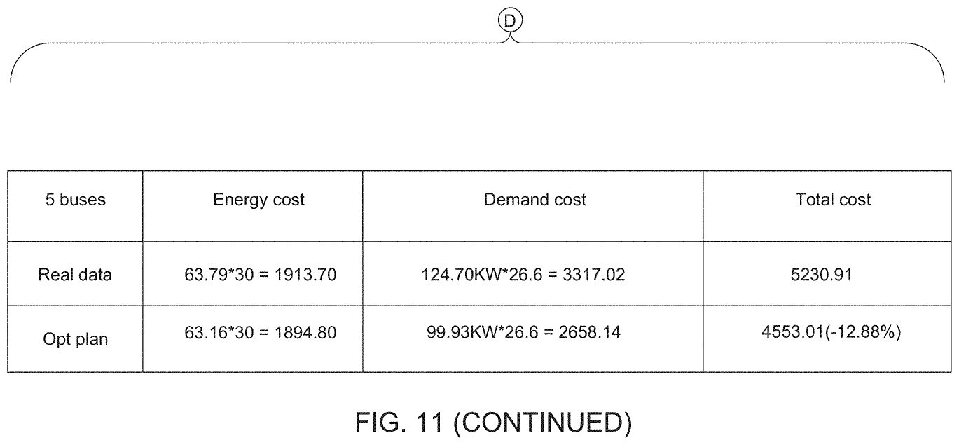

FIG. 11 shows the graphical representation showing results of continuous control on real charging info in exemplary embodiment of present invention. The graphs show the results of continuous control on real charging information, before the optimization plan 1102 and after the optimization plan 1104 and the analysis of the total cost of one month 1106 based on one day result before and after the optimization plan. The representation in FIG. 11 shows data on 5 EVs. As per the data, the energy cost was $1913.90 and Demand Charge was $3317.2 before the plan was taken. The total cost before the optimization plan was $5230.91. After the optimization plan had been taken, the energy cost was reduced to $1894.80 and demand charge was $2658.14, making total cost of $4553.01. Comparing the cost before and after the optimization, there is a substantial reduction of 12.88% in cost saving associated with charging the vehicles.

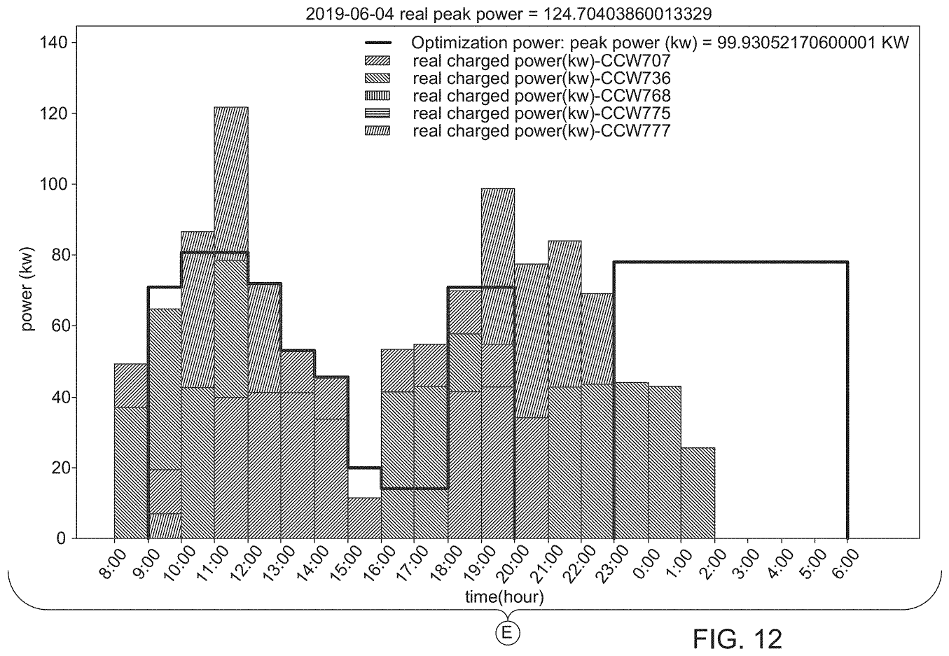

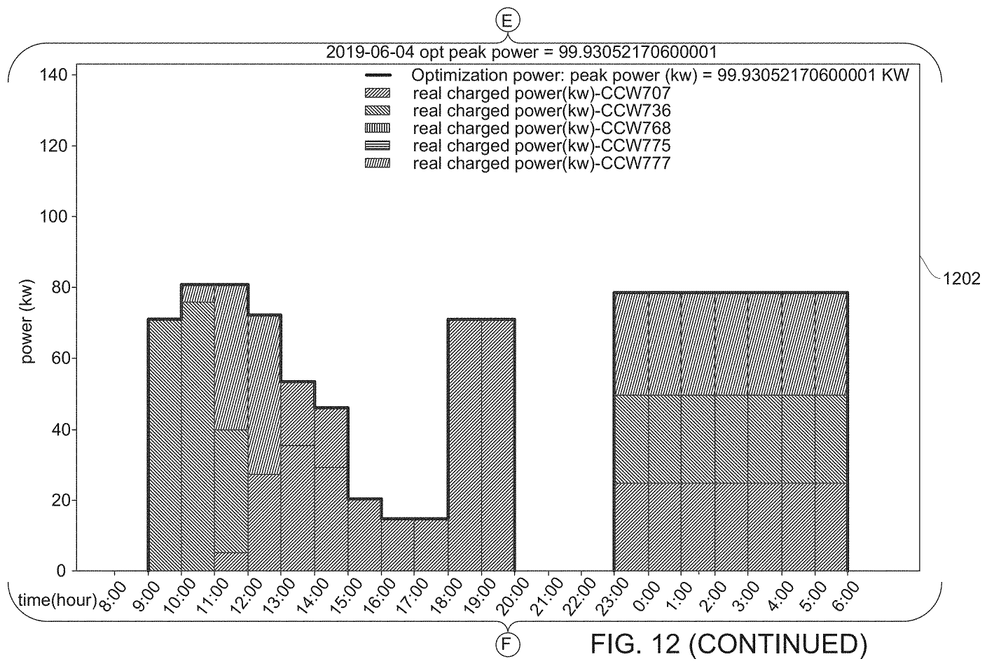

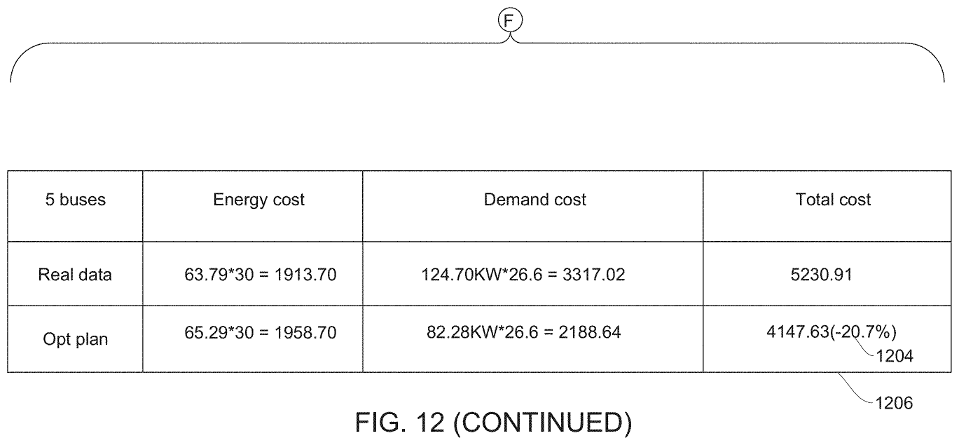

FIG. 12 shows the graphical representation showing results of continuous control on predicted charging info. The graphs show the results of continuous control on predicted charging info before the optimization plan 1202 and after the optimization plan 1204 and the analysis of the total cost of one month 1206 based on one day result before and after the optimization plan. The representation in FIG. 12 shows data on 5 EVs. As per the data, the energy cost was $1913.90 and demand charge was $3317.2 before the plan was taken. The total cost before the optimization plan was $5230.91. After the optimization plan had been taken, the energy cost was $1958.70 and demand charge was reduced to $2188.64, making total cost of $4147.63. Comparing the cost before and after the optimization plan, there is a substantial reduction of 20.77% in cost saving associated with charging the vehicle.

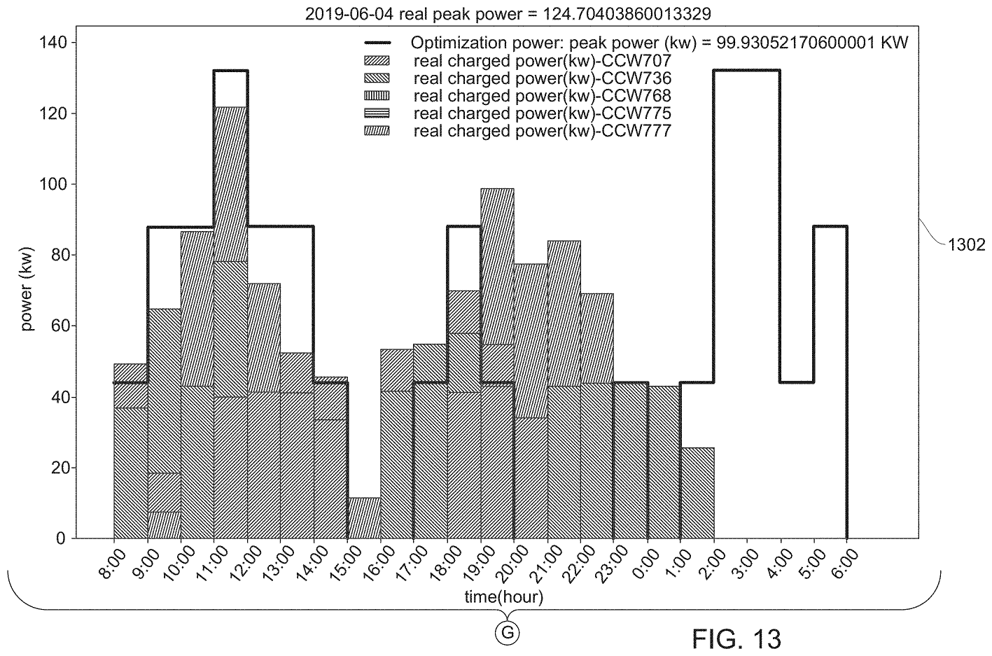

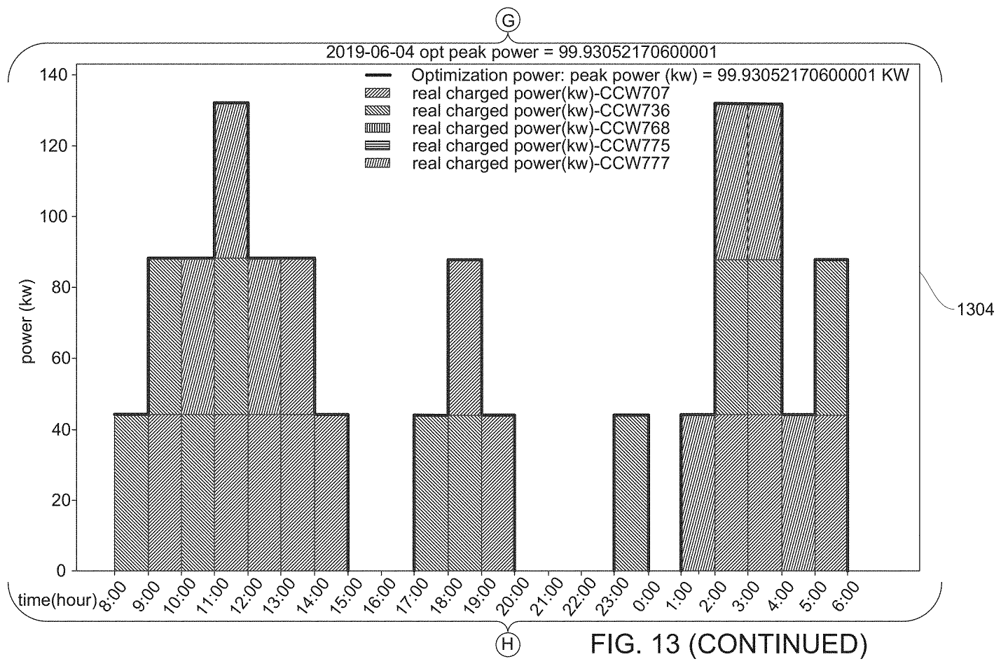

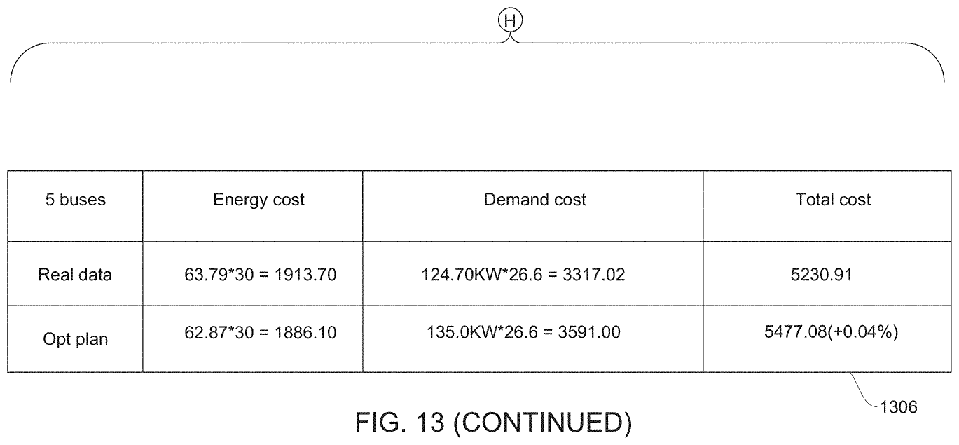

FIG. 13 shows the graphical representation showing results of discrete control on predicted charging info. The graphs show the results of discrete control on predicted charging info before the optimization plan 1302 and after the optimization plan 1304 and the analysis of the total cost of one month 1306 based on one day result before and after the optimization plan. The representation in FIG. 13 shows data on 5 EVs. As per the real data, the energy cost was $1941.00 and demand charge was $3762.57 before the plan was taken. The total cost before the optimization plan was $5703.18. After the optimization plan had been taken, the energy cost was $1482.60 and demand charge was reduced to $2394.00, making total cost of $3876.57. Comparing the cost before and after the optimization plan, there is a substantial reduction of 32.03% in cost saving associated with charging the vehicle.

In another embodiment of the present invention, the object of the present invention is maximization of utilization of renewable energy, whereby the objective is to maximize the use of local solar energy generated through the solar panels, instead of having that sent back to the electric grid.

The system controls the switch of the energy output of the local solar panel. It can be sent to the electric grid, or to the stationary batteries for future usage, or to the vehicle battery for charging directly.

The system takes solar energy as one of the energy resources to charge the vehicles. In the charging optimization algorithm, the system may define a variable corresponding to the solar energy. It can be included in the constraints of the energy required of the vehicles. In the objective function of the optimization, the use of solar panel energy for EV charging will decrease the overall electricity bill. Therefore, the solar energy usage is maximized to minimize the electricity bill. When there are vehicles waiting to be charged, the system considers the available energy resources, and uses the solar energy first to charge the vehicle to reduce the energy bill. When there is no vehicle to be charged, the solar energy can be stored in the stationary batteries system and be delivered to the charging station later when the vehicles are ready to be charged.

In another embodiment of present invention, the objective of present invention is to provide grid support, solving the California Independent System Operator (CAISO) Duck Curve on the grid, using maximum amount of renewable energy from the grid. The approaches used to resolve the power grid Duck Curve phenomenon are similar to those used to maximization of utilization of renewable energy as described above.

### Driver Behavior Classification

For the driver behavior classification, the system takes in the driver behavior related data, including speed, acceleration, energy used and regenerated and classifies the current driver's behavior using classification techniques in AI/ML algorithms. The classified driver behavior will help the system to predict the energy consumption and corresponding adjusted remaining mileage according to the information learned from historical data. The learned information is based on the energy consumption and driver's behavior data, and using clustering techniques to learn the estimated energy consumption rate for each category of the driver.

The foregoing merely illustrates the principles of the present invention. Other variations to the disclosed embodiments can be understood and effected by those skilled in the art in practicing the claimed invention from a study of the drawings, the disclosure, and the appended claims. In the claims, the word “comprising” does not exclude other elements or steps and the indefinite article “a” or “an” does not exclude a plurality. The mere fact that certain measures are recited in mutually different dependent claims does not indicate that a combination of these measures cannot be used advantageously. Any reference signs in the claims should not be construed as limiting the scope of the claims. Various modifications and alterations to the described embodiments will be apparent to those skilled in the art in view of the teachings herein. It will thus be appreciated that those skilled in the art will be able to devise numerous techniques which, although not explicitly described herein, embody the principles of the present invention and are thus within the spirit and scope of the present invention. All references cited herein are incorporated herein by reference in their entireties.

We claim:

1. A system for management of charging of electric vehicle, said system comprising:
a server to the data from a plurality of data sources connected through a network; the server is configured to:
determine the energy requirement and time of requirement by a vehicle by utilizing an artificial intelligence-based machine learning model;
perform optimization and generating a power flow sequence.
send control signals to each of a plurality of energy assets;
monitor and determine the plurality of energy assets are performing as per the control signal;
modify the control signal if the plurality of energy assets are not performing as per the control signal;
a display dashboard integrated with the server to display the vehicle information to a fleet manager;
a mobile application interface to display the vehicle information to a driver of the vehicle.

2. The system of claim 1, wherein the plurality of data source comprises charging stations, battery energy storage systems, renewable energy source, such as solar photovoltaic, fleet dashboard, traffic data, meteorological data, fleet telematics, power capacity information from electric grid and mobile application.

3. The system of claim 1, wherein the plurality of energy assets comprise EV charging stations, renewable energy source and battery energy storage systems.

4. The system of claim 1, wherein the optimization step comprises scheduling the power charging in combination with the power flows to any of the plurality of energy asset to achieve the maximized utilization of renewable source of energy.

5. The system of claim 1, wherein the display dashboard enables an operator to visualize real-time status about the vehicle and the charger.

6. The system of claim 1, wherein the mobile application interface display result based on the machine learning model to direct the driver to a precise EV charger location to optimize infrastructure usage and minimize electric bill.

7. The system of claim 1, wherein the system utilizes machine learning model to predict vehicle state of charge, upcoming trips and charging energy needs.

8. The system of claim 1, wherein the system predicts remaining driving range of the electric vehicle by developing an electric vehicle Trip Condition Training feature for training the machine learning model and an electric vehicle Trip Condition Prediction feature for predicting the remaining driving range from real-time data.

9. The system of claim 8, wherein the electric vehicle Trip Condition Training feature is generated from the historical data and electric vehicle Trip Condition Prediction feature is generated from real-time telematics and weather/traffic forecast data.

10. The system of claim 1, wherein the system is used for driving trip prediction to predict the potential driving route.

11. The system of claim 1, wherein the machine learning model utilizes telematics data coming from the fleet management system to predict arrival time of the electric vehicle at a charging station.

12. The system of claim 1, wherein the system performs energy consumption prediction of the electric vehicle to forecast the amount of energy the electric vehicle needs based on the real-time and historical telematics data.

13. The system of claim 1, wherein the system further comprises a method to optimize charging profile of the electric vehicle, said method comprising:
utilizing, by machine learning model, the telematics data of the electric vehicle to predict the starting and ending time of charging for the electric vehicle;
generating a time array of charging time for electric vehicle with a specified time interval;
mapping hourly billing charges with the time array;
generating a time profile corresponding to the hourly billing charges and the capacity of the charging station.
generating an optimized schedule for the charging power in combination with the power flows to any of the plurality of energy assets to achieve the maximum utilization of renewable source of energy and minimum electric bill while satisfying vehicle's energy need for the fleet operations.
